(19) United States
(12) Patent Application Publication
(10) Pub. No.: US 2013/0052948 A1
(43) Pub. Date: Feb. 28, 2013

(54) Signal Detector of a Near Field Communications (NFC) Device for Efficient Signal Detection

(71) Applicant: Franz Xaver FUCHS, Cheltenham (GB)

(72) Inventor: Franz Xaver FUCHS, Cheltenham (GB)

(73) Assignee: Broadcom Corporation, Irvine, CA (US)

(21) Appl. No.: 13/222,664

(22) Filed: Aug. 31, 2011

(51) Int. Cl. H04B 5/00

(52) U.S. Cl. 455/41.1

(57) ABSTRACT

A near field communications (NFC) device is disclosed that interacts with other NFC devices to exchange information and/or data. An antenna receives an input signal from another NFC device and a communication circuit processes the input signal. A signal detector may be used to detect an input current signal corresponding to the input signal received from the other NFC device. The signal detector can include a primary communication path and a secondary communication path. Through its proximity to the secondary communication path, the primary communication path induces the input current signal in the secondary communication path.

### BACKGROUND

1. Field of Invention

The invention relates to near field communications (NFC), and more specifically to detecting an input signal received by an NFC capable device.

2. Related Art

Near field communication (NFC) devices are being integrated into communication devices, such as mobile devices to provide an example, to facilitate the use of these communication devices in conducting daily transactions. For example, instead of carrying numerous credit cards, the credit information provided by these credit cards could be stored onto an NFC device. The NFC device is simply tapped to a credit card terminal to relay the credit information to the terminal to complete a transaction. As another example, a ticket writing system, such as is used in a bus or train terminal, may simply write ticket fare information onto the NFC device instead of providing a ticket to a passenger. The passenger simply taps the NFC device to a reader to ride the bus or the train without the use of a paper ticket.

Generally, NFC requires that NFC devices be present within a relatively small distance from one another so that their corresponding magnetic fields can exchange information. Typically, a first NFC device transmits or generates a magnetic field modulated with the information, such as the credit information or the ticket fare information. This magnetic field inductively couples the information onto a second NFC device that is proximate to the first NFC device, which is received by an antenna of the second NFC device. The second NFC device may respond to the first NFC device by inductively coupling its corresponding information onto an antenna of the first NFC device.

A voltage associated with the response signal varies depending on the distance between the first and second NFC devices. A large distance between the devices causes the received response signal to have a small voltage. Conversely, a small distance between the devices generates a received response signal with a large voltage. These received signals can cause an extremely large voltage to build up between the receiving antenna and the functional circuitry of the NFC device. This can cause damage to the functional elements of the NFC device, thereby causing the NFC device to malfunction or shorten the NFC device's useful lifespan.

In order to prevent the build-up of voltage levels that could be harmful to the functional NFC device circuitry, a regulator can be placed between the functional circuitry and the antenna to reduce the amount of voltage capable of reaching the functional circuitry. However, the regulator often excessively compensates the received input signal, such that the regulated input signal includes insufficient voltage levels to be properly read by the NFC functional circuitry.

Thus, there is a need for a way to inexpensively detect the information contained within the regulated input signal while protecting the NFC functional circuitry from the regulated voltage levels. Further aspects and advantages of the invention will become apparent from the detailed description that follows.

### BRIEF DESCRIPTION OF THE DRAWINGS/FIGURES

Embodiments of the invention are described with reference to the accompanying drawings. In the drawings, like reference numbers indicate identical or functionally similar elements. Additionally, the left most digit(s) of a reference number identifies the drawing in which the reference number first appears.

FIG. 1 illustrates a block diagram of an NFC environment according to an exemplary embodiment of the invention;

FIG. 2 illustrates a block diagram of a first NFC device that is implemented as part of the NFC environment according to an exemplary embodiment of the invention;

FIG. 3 illustrates a block diagram of an antenna module that is implemented as part of the first NFC device according to an exemplary embodiment of the invention;

FIG. 4 graphically illustrates a communications chip with a first configuration of a signal detector that is implemented as part of the first NFC device according to an exemplary embodiment of the invention;

FIG. 5A graphically illustrates the communications chip with a second configuration of a signal detector that is implemented as part of the first NFC device according to an exemplary embodiment of the invention;

FIG. 5B graphically illustrates the communications chip with a third configuration of a signal detector that is implemented as part of the first NFC device according to an exemplary embodiment of the invention; and

FIG. 6 illustrates a block diagram of a method for detecting an input current signal according to an exemplary embodiment of the invention.

The invention will now be described with reference to the accompanying drawings. In the drawings, like reference numbers generally indicate identical, functionally similar, and/or structurally similar elements. The drawing in which an element first appears is indicated by the leftmost digit(s) in the reference number.

### DETAILED DESCRIPTION OF THE INVENTION

The following Detailed Description refers to accompanying drawings to illustrate exemplary embodiments consistent with the invention. References in the Detailed Description to “one exemplary embodiment,” “an exemplary embodiment,” “an example exemplary embodiment,” etc., indicate that the exemplary embodiment described may include a particular feature, structure, or characteristic, but every exemplary embodiment may not necessarily include the particular feature, structure, or characteristic. Moreover, such phrases are not necessarily referring to the same exemplary embodiment. Further, when a particular feature, structure, or characteristic is described in connection with an exemplary embodiment, it is within the knowledge of those skilled in the relevant art(s) to affect such feature, structure, or characteristic in connection with other exemplary embodiments whether or not explicitly described.

The exemplary embodiments described herein are provided for illustrative purposes, and are not limiting. Other exemplary embodiments are possible, and modifications may be made to the exemplary embodiments within the spirit and scope of the invention. Therefore, the Detailed Description is not meant to limit the invention. Rather, the scope of the invention is defined only in accordance with the following claims and their equivalents.

Embodiments of the invention may be implemented in hardware, firmware, software, or any combination thereof. Embodiments of the invention may also be implemented as instructions stored on a machine-readable medium, which may be read and executed by one or more processors. A machine-readable medium may include any mechanism for storing or transmitting information in a form readable by a machine (e.g., a computing device). For example, a machine-readable medium may include read only memory (ROM); random access memory (RAM); magnetic disk storage media; optical storage media; flash memory devices; electrical, optical, acoustical or other forms of propagated signals (e.g., carrier waves, infrared signals, digital signals, etc.), and others. Further, firmware, software, routines, instructions may be described herein as performing certain actions. However, it should be appreciated that such descriptions are merely for convenience and that such actions in fact results from computing devices, processors, controllers, or other devices executing the firmware, software, routines, instructions, etc.

The following Detailed Description of the exemplary embodiments will so fully reveal the general nature of the invention that others can, by applying knowledge of those skilled in relevant art(s), readily modify and/or adapt for various applications such exemplary embodiments, without undue experimentation, without departing from the spirit and scope of the invention. Therefore, such adaptations and modifications are intended to be within the meaning and plurality of equivalents of the exemplary embodiments based upon the teaching and guidance presented herein. It is to be understood that the phraseology or terminology herein is for the purpose of description and not of limitation, such that the terminology or phraseology of the present specification is to be interpreted by those skilled in relevant art(s) in light of the teachings herein.

Although the description of the present invention is to be described in terms of near field communication (NFC), those skilled in the relevant art(s) will recognize that the present invention may be applicable to other communications that use the near field and/or the far field without departing from the spirit and scope of the present invention. For example, although the present invention is to be described using NFC capable communication devices, those skilled in the relevant art(s) will recognize that functions of these NFC capable communication devices may be applicable to other communications devices that use the near field and/or the far field without departing from the spirit and scope of the present invention.

An Exemplary Near Field Communications (NFC) Environment

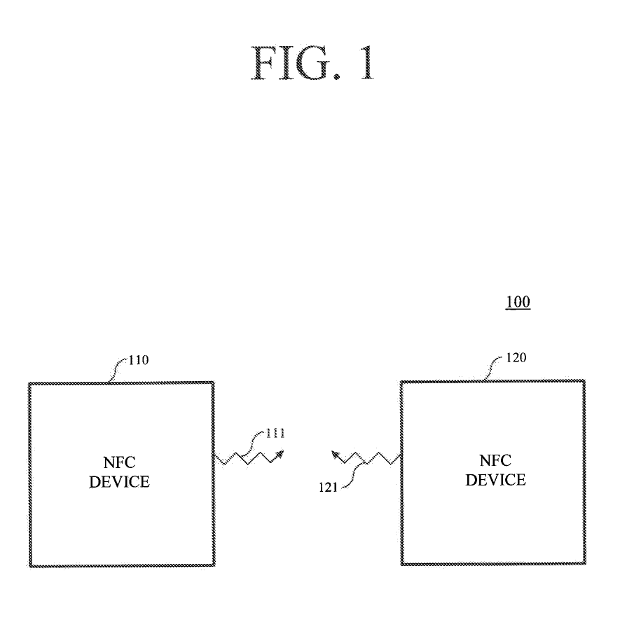

FIG. 1 illustrates a block diagram of an NFC environment according to an exemplary embodiment of the invention. An NFC environment 100 provides wireless communication of information, such as one or more commands and/or data, among a first NFC device 110 and a second NFC device 120 that are sufficiently proximate to each other. The first NFC device 110 and/or the second NFC device 120 may be implemented as a standalone or a discrete device or may be incorporated within or coupled to another electrical device or host device, such as a mobile telephone, a portable computing device, another computing device such as a personal digital assistant, a laptop, or a desktop computer, a computer peripheral such as a printer, a portable audio and/or video player, a payment system, a ticketing writing system such as a parking ticketing system, a bus ticketing system, a train ticketing system or an entrance ticketing system to provide some examples, or in a ticket reading system, a toy, a game, a poster, packaging, advertising material, a product inventory checking system and/or any other suitable electronic device that will be apparent to those skilled in the relevant art(s) without departing from the spirit and scope of the invention.

The first NFC device 110 and the second NFC device 120 interact with each other to exchange the information, in a peer (P2P) communication mode or a reader/writer (R/W) communication mode. In the P2P communication mode, the first NFC device 110 and the second NFC device 120 may be configured to operate according to an active communication mode and/or a passive communication mode. The first NFC device 110 modulates its corresponding information onto a first carrier wave, referred to as a modulated information communication, and generates a first magnetic field by applying the modulated information communication to the first antenna to provide a first information communication 111. The first NFC device 110 ceases to generate the first magnetic field after transferring its corresponding information to the second NFC device 120 in the active communication mode. Alternatively, in the passive communication mode, the first NFC device 110 continues to apply the first carrier wave without its corresponding information, referred to as an unmodulated information communication, to continue to provide the first information communication 111 once the information has been transferred to the second NFC device 120.

The first NFC device 110 is sufficiently proximate to the second NFC device 120 such that the first information communication 111 is inductively coupled onto a second antenna of the second NFC device 120. The second NFC device 120 demodulates the first information communication 111 to recover the information. The second NFC device 120 may respond to the information by modulating its corresponding information onto a second carrier wave and generating a second magnetic field by applying this modulated information communication to the second antenna to provide a second information communication 121 in the active communication mode. Alternatively, the second NFC device 120 may respond to the information by modulating the second antenna with its corresponding information to modulate the first carrier wave to provide the second information communication 121 in the passive communication mode.

In the R/W communication mode, the first NFC device 110 is configured to operate in an initiator, or reader, mode of operation and the second NFC device 120 is configured to operate in a target, or tag, mode of operation. However, this example is not limiting. Those skilled in the relevant art(s) will recognize that the first NFC device 110 may be configured to operate in the tag mode and the second NFC device 120 may be configured to operate in the reader mode in accordance with the teachings herein without departing from the spirit and scope of the present invention. The first NFC device 110 modulates its corresponding information onto the first carrier wave and generates the first magnetic field by applying the modulated information communication to the first antenna to provide the first information communication 111. The first NFC device 110 continues to apply the first carrier wave without its corresponding information to continue to provide the first information communication 111 once the information has been transferred to the second NFC device 120. The first NFC device 110 is sufficiently proximate to the second NFC device 120 such that the first information communication 111 is inductively coupled onto a second antenna of the second NFC device 120.

The second NFC device 120 derives or harvests power from the first information communication 111 to recover and/or process the received information, and/or to provide a response to the information. The second NFC device 120 demodulates the first information communication 111 to recover and/or to process the information. The second NFC device 120 may respond to the information by modulating the second antenna with its corresponding information to modulate the first carrier wave to provide the second information communication 121.

Further operations of the first NFC device 110 and/or the second NFC device 120 may be described in International Standard ISO/IE 18092:2004(E), “Information Technology—Telecommunications and Information Exchange Between Systems—Near Field Communication—Interface and Protocol (NFCIP-1),” published on Apr. 1, 2004 and International Standard ISO/IE 21481:2005(E), “Information Technology—Telecommunications and Information Exchange Between Systems—Near Field Communication—Interface and Protocol-2 (NFCIP-2),” published on Jan. 15, 2005, each of which is incorporated by reference herein in its entirety.

A First Exemplary NFC Device

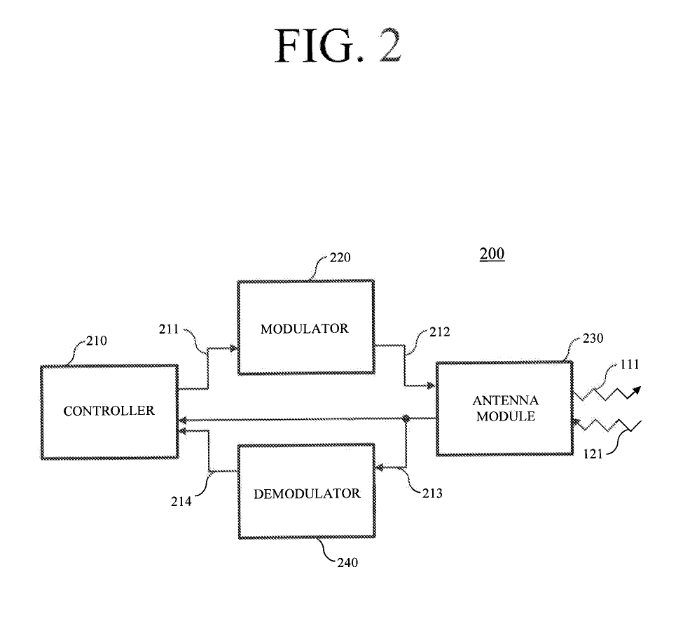

FIG. 2 illustrates a block diagram of an NFC device that is implemented as part of the NFC environment according to an exemplary embodiment of the invention. The NFC device 200 includes a controller 210, a modulator 220, the antenna module 230, and a demodulator 240. The NFC device 200 may represent an exemplary embodiment of the NFC device 110 and/or the second NFC device 120.

The controller 210 controls overall operation and/or configuration of the NFC device 200. The controller 210 receives information from one or more data storage devices (not shown in FIG. 2), such as one or more contactless transponders, one or more contactless tags, one or more contactless smartcards, any other machine-readable mediums that will be apparent to those skilled in the relevant art(s) without departing from the spirit and scope of the invention, or any combination thereof. The other machine-readable medium may include, but is not limited to, read only memory (ROM), random access memory (RAM), magnetic disk storage media, optical storage media, flash memory devices, electrical, optical, acoustical or other forms of propagated signals such as carrier waves, infrared signals, digital signals to provide some examples. The controller module 210 may also receive the information from a user interface (not shown), such as a touch-screen display, an alphanumeric keypad, a microphone, a mouse, a speaker, or any other suitable user interface that will be apparent to those skilled in the relevant art(s) without departing from the spirit and scope of the invention to provide some examples. The controller module 210 may further receive the information from other electrical devices or host devices coupled to the NFC device 200.

Typically, the controller 210 provides the received information as transmission information 211 for transmission to another NFC capable device. However, the controller 210 may also use the received information to control the overall operation and/or configuration of the NFC device 200. For example, the controller 210 may issue and/or execute one or more commands in accordance with the received information, if appropriate, to control operations of the NFC device 200, such as transmission power, transmission data rate, transmission frequency, modulation scheme, bit and/or a byte encoding scheme and/or any other suitable operation parameter that will be apparent to those skilled in the relevant art(s) without departing from the spirit and scope of the invention, of other NFC capable devices.

Additionally, the controller 210 may format the received information into information frames and may perform error encoding, such as cyclic redundancy check (CRC) to provide an example, on the information frames to provide the transmission information 211. The information frames may include frame delimiters to indicate a start and/or an end of each of the information frames. The controller module 210 may additionally arrange multiple information frames to form sequences of information frames to synchronize and/or to calibrate the NFC device 200 and/or another NFC capable device. The sequences may include sequence delimiters to indicate a start and/or an end of each of the sequences.

Further, the controller module 210 may perform other functionality as described in International Standard ISO/IE 18092:2004(E), “Information Technology—Telecommunications and Information Exchange Between Systems—Near Field Communication—Interface and Protocol (NFCIP-1),” published on Apr. 1, 2004 and International Standard ISO/IE 21481:2005(E), “Information Technology—Telecommunications and Information Exchange Between Systems—Near Field Communication—Interface and Protocol-2 (NFCIP-2),” published on Jan. 15, 2005, each of which is incorporated by reference herein in its entirety.

The modulator 220 modulates the transmission information 211 onto a carrier wave, such as a radio frequency carrier wave having a frequency of approximately 13.56 MHz to provide an example, using any suitable analog or digital modulation technique to provide a modulated information communication as transmission information 212. The suitable analog or digital modulation technique may include amplitude modulation (AM), frequency modulation (FM), phase modulation (PM), phase shift keying (PSK), frequency shift keying (FSK), amplitude shift keying (ASK), quadrature amplitude modulation (QAM) and/or any other suitable modulation technique that will be apparent to those skilled in the relevant art(s). The modulator 220 may continue to provide the carrier wave to provide an unmodulated information communication as the transmission information 212 once the transmission information 211 has been transferred to another NFC capable device. Alternatively, the modulator 220 may cease to provide the transmission information 212 once the transmission information 211 has been transferred to another NFC capable device.

The antenna module 230 applies the transmission information 212 to an inductive coupling element, such as a resonant tuned circuit to provide an example, to generate a magnetic field to transmit the first information communication 111. Additionally, another NFC capable device may inductively couple the second information communication 121 onto the inductive coupling element to provide a recovered communication signal 213. For example, this other NFC capable device may respond to the information by modulating its corresponding antenna with its corresponding information to modulate the carrier wave to provide the second information communication signal 121 to the antenna module 230. As another example, this other NFC capable device may modulate its corresponding information onto its corresponding carrier wave and generate its corresponding magnetic field by applying this modulated information communication to its corresponding antenna to provide the second information communication signal 121 to the antenna module 230.

The demodulator 240 demodulates the recovered communication signal 213 using any suitable analog or digital modulation technique to provide reception information 214. The suitable analog or digital modulation technique may include amplitude modulation (AM), frequency modulation (FM), phase modulation (PM), phase shift keying (PSK), frequency shift keying (FSK), amplitude shift keying (ASK), quadrature amplitude modulation (QAM) and/or any other suitable modulation technique that will be apparent to those skilled in the relevant art(s).

Typically, the controller 210 provides the reception information 214 as recovered information to the data store, the user interface, and/or other electrical devices or host devices. However, the controller 210 may also use the reception information 214 to control the overall operation and/or configuration of the NFC device 200. The reception information 214 may include one or more commands and/or data. The controller 210 may issue and/or execute the one or more commands to control the overall operation and/or configuration of the NFC device 200. For example, the controller 210 may issue and/or execute the one or more commands in accordance with the data, if appropriate, to control operations of the NFC device 200, such as transmission power, transmission data rate, transmission frequency, modulation scheme, bit and/or byte encoding scheme and/or any other suitable operation parameter that will be apparent to those skilled in the relevant art(s) without departing from the spirit and scope of the invention, of other NFC capable devices.

Additionally, the controller 210 formats the reception information 214 into a suitable format for transmission to the data store, the user interface, and/or other electrical devices or host devices, and may perform error decoding, such as cyclic redundancy check (CRC) decoding to provide an example, on the reception information 214 to provide the recovered information.

Further, the controller 210 may receive the recovered communication signal 213 from the antenna module 230 to be analyzed and/or processed. For example, the controller 210 can determine one or more signal metrics of the recovered communication signal 213. The one or more signal metrics may include a mean voltage and/or current level, an average voltage and/or current level, an instantaneous voltage and/or current level, a root mean square voltage and/or current level, a mean power, an average power, an instantaneous power, a root mean square power, a frequency, a phase and/or any other suitable signal metric of the recovered communication signal 213 which will be apparent to those skilled in the relevant art(s) without departing from the spirit and scope of the invention.

Exemplary Operation of the Antenna Module that is Implemented as Part of the NFC Device

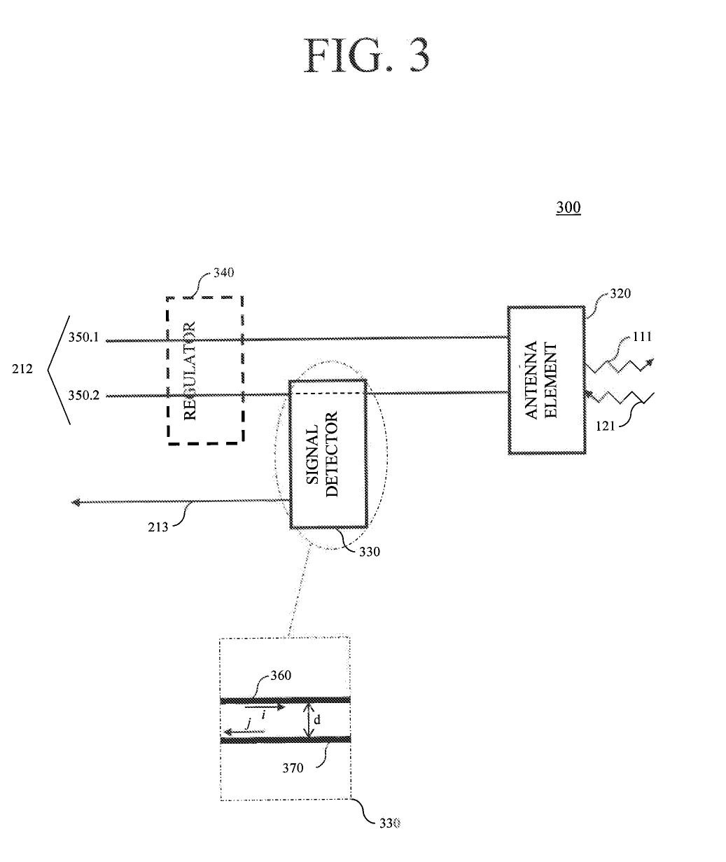

FIG. 3 illustrates a block diagram of the antenna module that is implemented as part of the NFC device according to an exemplary embodiment of the invention. Generally, an antenna module 300 provides the first information communication 111 by varying a voltage across an inductive coupling element and/or by passing an electric current through the inductive coupling element. Similarly, the second information communication 121 causes the voltage across the inductive coupling element to vary and/or the electric current to flow through the inductive coupling element. The antenna module 300 may inductively detect the electric current flowing through the inductive coupling element. The antenna module 300 includes an antenna element 320, and a signal detector 330, and an optional regulator module 340. The antenna module 300 may represent an exemplary embodiment of the antenna module 230.

The antenna module 300 may operate in a transmission mode of operation and/or a reception mode of operation. In the transmission mode of operation, the antenna module 300 provides the first information communication 111 to another NFC capable device. Similarly, the antenna module 300 receives the second information communication 121 from another NFC capable device in the reception mode of operation. The operation of the antenna module 300 in each of these modes of operation is to be further discussed below.

The antenna element 320 includes the inductive coupling element for transmitting the first information communication 111 and/or receiving the second information communication 121. Typically, the transmission information 212 represents a differential communication signal having a first component 350.1 and a second component 350.2. However, those skilled in the relevant art(s) will recognize that the transmission information 212 may also be a single-end communications signal without departing from the spirit and scope of the present invention. In the transmission mode of operation, the antenna module 300 applies the first component 350.1 and the second component 350.2 to the inductive coupling element to generate a magnetic field to provide the first information communication 111. In the reception mode of operation, another NFC capable communications device inductively couples the second information communication 121 to the inductive coupling element to provide the first component 350.1 and the second component 350.2.

The signal detector module 330 inductively detects the electric current flowing through the second component 350.2 to provide the recovered communication signal 213. However, those skilled in the relevant art(s) will recognize that the signal detector module 330 may similarly detect the electric current flowing through the first component 350.1 without departing from the spirit and scope of the present invention. As shown in FIG. 3, the signal detector module 330 includes a primary communication path 360 and a secondary communication path 370. As discussed later, the primary communication path 360 can be a conductor that carries the signal passing through the second component 350.2. The primary communication path 360 and the secondary communication path 370 are configured and arranged to form any suitable structure such as a transformer to provide an example that allows the secondary communication path 370 to detect an electric current i flowing through the primary communication path 360. For example, the primary communication path 360 may be implemented using a first bond wire and the secondary communication path 370 may be implemented using a second bond wire that is substantially parallel to the first bond wire. In this example, the electric current flowing through the first bond wire is inductively coupled onto the second bond wire to provide the recovered communication signal 213. Alternatively, the primary communication path 360 and/or the secondary communication path 370 may be similarly implemented using inductors or other discrete transformers to provide some examples, each having a number of turns.

Specifically, as shown in exploded view of the signal detector module 330, the primary communication path 360 is disposed in proximity to secondary communication path 370. As shown in the exploded view, the primary communication path 360 and secondary communication path 370 are separated by a distance d. The distance d should be sufficiently close to allow the electric current i flowing through the primary communication path 360 to induce a current j onto the secondary communication path 370. Induction of the electric current i in this manner galvanically isolates many of the functional elements used in the transmission mode of operation from those used in the reception mode of operation. The induced electric current j that is induced in the secondary communication path 370 may be represented as:

j=k*i, (1)

where k represents a scaling factor that depends on the distance d as well as a number of turns in the primary communication path 360 and the secondary communication path 370. Typically, the electric current j is a substantial replica of the induced electric current i. For example, the electric current i flowing through the primary communication path 360 may include information embedded within the transmission information 212 and/or the second information communication 121. In this example, the induced electric current j flowing through the secondary communication path 370 may be embedded with a substantial replica of the information.

The optional regulator 340 regulates a voltage of the first component 350.1 and/or the second component 350.2. In some situations, a voltage across the antenna element 320, namely a voltage difference between the first component 350.1 and the second component 350.2, may damage the antenna module 300. In these situations, the optional regulator 340 substantially reduces this voltage to prevent damage to the antenna module 300. The optional regulator 340 adjusts the first component 350.1 and/or the second component 350.2 using any number of, or combination of, voltage transformers, voltage divider circuits, impedance elements and transistors.

Exemplary Signal Detectors that are Implemented as Part of the First NFC Device

Referring back to FIG. 2, typically the NFC device 200 is implemented onto one or more semiconductor chips or dies. For example, the controller 210, the modulator 220, and the demodulator 240 may be formed onto a first group of one or more semiconductor chips or dies and the antenna module 230 may be formed onto a second group of one or more semiconductor chips or dies. In this example, the first group of one or more semiconductor chips or dies is coupled to one or more bonding pads. These bonding pads are then coupled to one or more bond fingers of a substrate, a die attach pad (DAP), or leads of a leadframe using one or more bond wires to form an integrated circuit package. The integrated circuit package is coupled to other integrated circuit packages that include the second group of one or more semiconductor chips or dies to form the NFC device 200.

First Exemplary Signal Detector

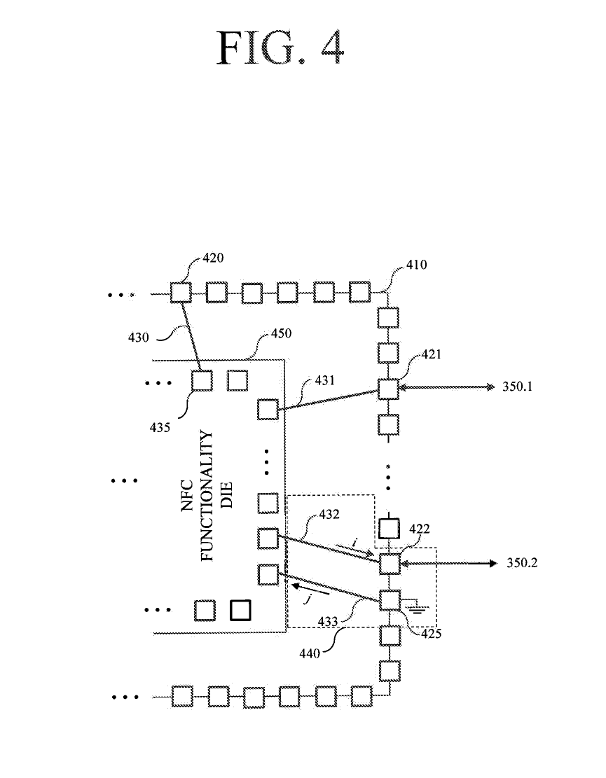

FIG. 4 graphically illustrates a first configuration of a signal detector that is implemented as part of the NFC device according to an exemplary embodiment of the invention. In this first configuration, one or more modules of an NFC device, such as one or more of the controller 210, the modulator 220, and the demodulator 240 to provide some examples, may be formed within an integrated circuit package 410. The integrated circuit package 410 may be coupled to one or more other integrated circuit packages to form the NFC device.

The integrated circuit package 410 includes an NFC functionality chip or die 450. The NFC functionality chip or die includes the one or more modules of an NFC device that are formed onto a common semiconductor chip or die. The NFC functionality chip or die 450 also includes a plurality of bond pads 435 for coupling the NFC functionality chip or die 450 to the integrated circuit package 410. Each of the plurality of bond pads 435 represents a metallized area on the surface of the NFC functionality chip or die 450 for making electrical connections between the on-chip components and off-chip components, namely those components which are external to the NFC functionality chip or die 450.

Typically, components of the NFC device which are included within or internal to the NFC functionality chip or die 450 are referred to as on-chip components. Whereas components of the NFC device which are external to the NFC functionality chip or die 450 are referred to as off-chip components.

The integrated circuit package 410 includes a plurality of bonding fingers 420 for connecting the on-chip components to the off-chip components. A plurality of bond wires 430 form electrical connections between the on-chip components and the off-chip components, and are typically formed of a high-gauge tensile conducting wire, such as gold or aluminum, for example. For example, as shown in FIG. 4, the first component 350.1 is coupled to a bonding finger 421 from among the plurality of bonding fingers 420 within the integrated circuit package 410. A bond wire 431 connects the bonding finger 421 to a corresponding bond pad 435 formed on the NFC functionality die 450. Likewise, the second component 350.2 is connected to a bonding finger 422 from among the plurality of bonding fingers 420 formed on the integrated circuit package 410. A bond wire 432 connects the bonding finger 422 to a corresponding bond pad 435 formed on the NFC functionality die 450.

In this first configuration, the bond wire 432 and a bond wire 433 are configured and arranged to form a signal detector 440. The signal detector 440 may represent an exemplary embodiment of the signal detector 330. As such, the bond wire 432 may represent an exemplary embodiment of the primary communication path 360 and the bond wire 433 may represent an exemplary embodiment of the secondary communication path 370. The bond wire 433 couples a bonding finger 425 from among the plurality of bonding fingers 420 to a corresponding bond pad 435 formed on the NFC functionality die 450. Typically, the bond wire 433 is disposed substantially parallel to the bond wire 432 such that the electric current i flowing though the bond wire 432 is inductively coupled onto the bond wire 433 to provide the induced electric current j. In an exemplary embodiment, the bond wire 433 can be connected to a ground terminal through the bonding finger 425. The bonding finger 425 is preferably located directly adjacent to the bonding finger 422 to minimize a separation distance between the bond wire 432 and the bond wire 433, thereby maximizing the induced electric current j in the bond wire 433. However, bonding finger 425 can also be separated from the bonding finger 422 by additional bonding fingers from among the plurality of bonding fingers 420.

Second Exemplary Signal Detector

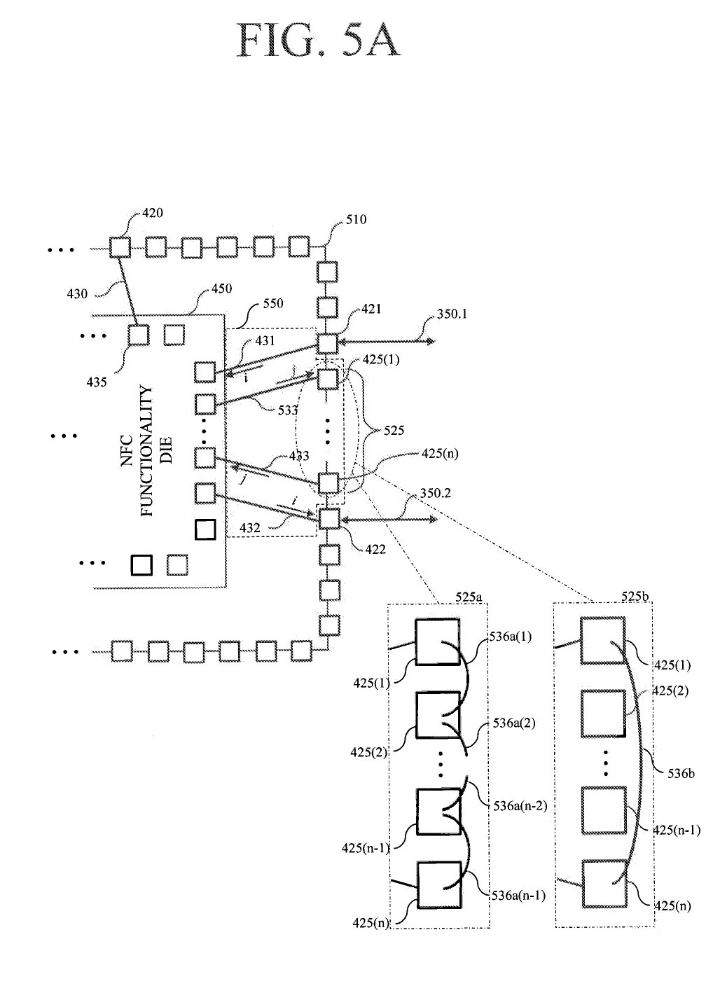

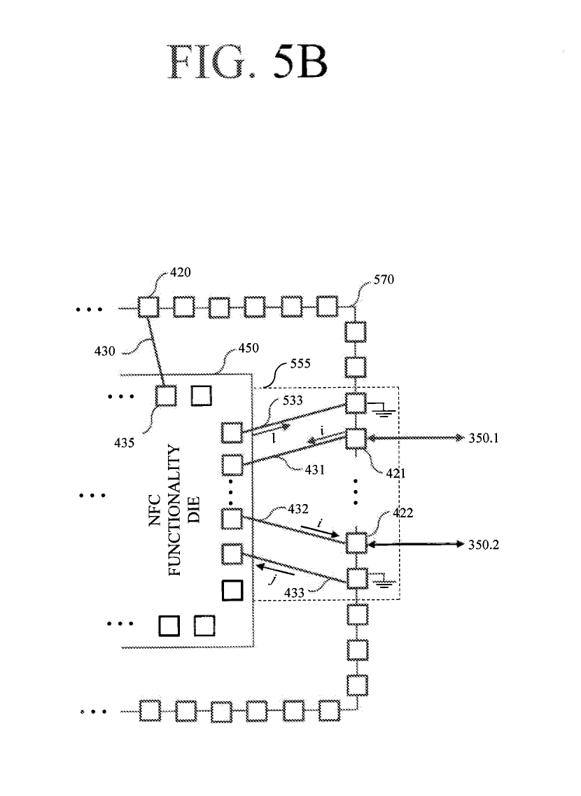

FIG. 5A graphically illustrates a second configuration of a signal detector that is implemented as part of an NFC device according to an exemplary embodiment of the invention. In this configuration, an integrated circuit package 510 maintains many of the features and configurations of the integrated circuit package 410. Therefore, only differences between the integrated circuit package 510 and the integrated circuit package 410 will be discussed in further detail.

According to the exemplary embodiment of FIG. 5A, the bond wire 432 and the bond wire 433 are configured and arranged along with the bond wire 431 and a bond wire 533 to form a signal detector 550. The signal detector 550 may represent an exemplary embodiment of the signal detector 330. In this embodiment, the bond wire 533 is coupled to the bond wire 433 through a connection 525. As such, the bond wire 432 and the bond wire 431 may represent an exemplary embodiment of the first primary communication path 360 and the bond wire 433 and the bond wire 533 may represent an exemplary embodiment of a first secondary communication path 370. Preferably, the distance between bond wire 431 and the bond wire 533 is the same, or substantially the same, as the distance between the bond wire 433 and the bond wire 432.

The bond wire 533 can be connected to the bond wire 433 in a variety of ways. For example, the connection 525 between the bond wire 533 and the bond wire 433 can include a plurality of bonding fingers 420, connected to one another by a plurality of bond wires. The exploded view 525a shows one exemplary configuration of the connection 525. In the exploded view 525a, the bond wire 433 is connected to a bonding finger 425(n) and the bond wire 533 is connected to bonding finger 425(1).

A plurality of bond wires 536a serially connect each adjacent pair of bonding fingers 425 in between the bonding fingers 425(1) and 425(n).

Exploded view 525b shows an alternative construction of the connection 525. For example, a single wire 536b can connect the bonding finger 425(1) to the bonding finger 425(n). The wire 536b is preferably a PCB wire, but can also be a bond wire, depending on application.

Those skilled in the art will recognize that many other configurations are available for connecting the pads 425(1) and 425(n), including any combination of the above-discussed configurations, or a direct connection between the bond wire 433 and the bond wire 533 to form a simple current loop.

This embodiment includes two pairs of bond wires, including a first pair consisting of bond wire 431 and bond wire 533 and a second pair consisting of bond wire 432 and bond wire 433, and provides multiple advantages in the signal detector. For example, provided that the distances between each pair of bond wires are substantially equal to one another, the current i can be more accurately detected. For example, although the current i flowing through the bond wire 431 and the bond wire 432 should be equivalent, many factors can affect the signal qualities of these currents, such as noise, interference and parasitic capacitances. Thus, by including a second pair of bond wires, and by connecting the bond wire 533 to the bond wire 433, the signal detector can automatically compensate for a signal quality reduction that occurs in one of the bond wire 431 or the bond wire 432.

Third Exemplary Signal Detector

FIG. 5B graphically illustrates a third configuration of a signal detector that is implemented as part of an NFC device according to an exemplary embodiment of the invention. In this embodiment, similar to the integrated circuit package 510, an integrated circuit package 570 includes two pairs of bond wires are again configured and arranged to form a signal detector 555. However, in this embodiment the bond wire 533 and the bond wire 433 are not connected to each other using a bond wire(s), but rather are each connected to a common voltage source/sink, such as a ground terminal. The signal detector 555 may represent an exemplary embodiment of the signal detector 330.

The bond wire 533 should be positioned sufficiently close to the bond wire 431, such that the current i passing through the bond wire 431 induces a current l in the bond wire 533. As discussed above, a distance between the bond wire 533 and the bond wire 431 should be substantially equal to the distance between the bond wire 433 and the bond wire 432. The current l induced in the bond wire 533 will follow the relationship of equation (1), where the scaling factor k will depend on the distance between the bond wire 431 and the bond wire 533. Thus, it is preferable that the distance between the bond wire 431 and the bond wire 533 equal the distance between the bond wire 433 and the bond wire 432. In this manner, the induced current l in the bond wire 533 should be equal to the current j induced in the bond wire 433.

This configuration also provides many advantages. For example, as discussed above, external forces can distort the current i passing through one of the bond wires 431/432. By including two pairs of bond wires, and by not connecting the bond wires 533 and 433 to each other, the signal detector acquires two separate induced current signals j and l. The controller 210 can implement various processings on the two input current signals j and l to accurately detect the undistorted current i. Additionally, the controller 210 can perform various stereoscopic processings on the two input current signals, including correlating, averaging, or phase alignment of the two received signals j and l.

An Exemplary Method of Detecting an Input Current Signal Included in an Input Signal

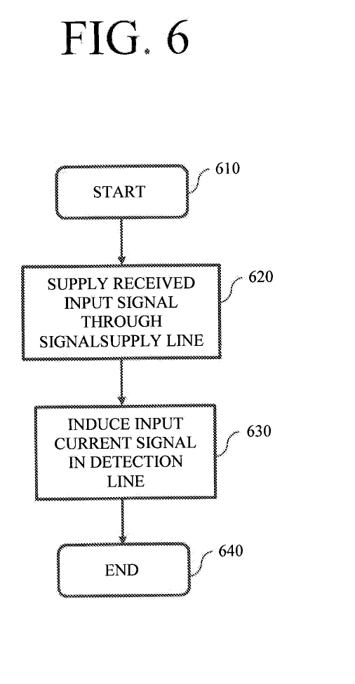

FIG. 6 illustrates a block diagram of a method for detecting an input current signal of a received input signal received by an NFC device according to an exemplary embodiment of the invention.

The method begins at step 610 and immediately proceeds to step 620. In step 620, the received input signal is supplied through a primary communication path. The method then proceeds to step 630. In step 630, while the received input signal is being supplied through the primary communication path, the primary communication path induces an input current signal in a secondary communication path through the proximity of the primary communication path to the secondary communication path. Once the input current signal has been induced in the secondary communication path, the method proceeds to step 640. In step 640, the method ends.

Those skilled in the relevant art(s) will recognize that the method can additionally or alternatively include any of the functionality of the signal detectors discussed above, and the above description of the exemplary method should neither be construed to limit the method nor the description of the NFC device 200.

### CONCLUSION

It is to be appreciated that the Detailed Description section, and not the Abstract section, is intended to be used to interpret the claims. The Abstract section may set forth one or more, but not all exemplary embodiments, of the invention, and thus, are not intended to limit the invention and the appended claims in any way.

The invention has been described above with the aid of functional building blocks illustrating the implementation of specified functions and relationships thereof. The boundaries of these functional building blocks have been arbitrarily defined herein for the convenience of the description. Alternate boundaries may be defined so long as the specified functions and relationships thereof are appropriately performed.

It will be apparent to those skilled in the relevant art(s) that various changes in form and detail can be made therein without departing from the spirit and scope of the invention. Thus the invention should not be limited by any of the above-described exemplary embodiments, but should be defined only in accordance with the following claims and their equivalents.

What is claimed is:

1. An NFC communications device, comprising:
a device input configured to receive an input signal;
a communication circuit configured to process the input signal; and
a signal detector configured to generate a current signal representative of the input signal, the signal detector including:
a primary communication path configured to supply the input signal from the device input to the communication circuit; and
a secondary communication path configured to have induced therein, through proximity of the secondary communication path to the primary communication path, the current signal.

2. The NFC communications device according to claim 1, wherein the primary communication path is a first bond wire and the secondary communication path is a second bond wire.

3. The NFC communications device according to claim 2, further comprising:
an integrated circuit package configured and arranged to house the communication circuit, the integrated circuit package including a plurality of bonding fingers disposed on a surface of the integrated circuit package,
wherein the primary communication path is configured to connect the communication circuit to a first bonding finger from among the plurality of bonding fingers, and
the secondary communication path is configured to connect the communication circuit to a bonding finger from among the plurality of bonding fingers.

4. The NFC communications device according to claim 3, wherein the second bonding finger is configured and arranged to be immediately adjacent to the first bonding finger.

5. The NFC communications device according to claim 2, wherein the secondary communication path is configured and arranged to be connected to a ground potential.

6. The NFC communications device according to claim 2, wherein the secondary communication path is configured to originate and to terminate at the communication circuit.

7. The NFC communications device according to claim 1, wherein the signal detector further includes:
a second primary communication path; and
a second secondary communication path.

8. The NFC communications device according to claim 7, wherein the primary communication path is a first bond wire,
wherein the secondary communication path is a second bond wire,
wherein the second primary communication path is a third bond wire, and
wherein the second secondary communication path is a fourth bond wire.

9. The NFC communications device according to claim 8, further comprising:
an integrated circuit package configured to house the communication circuit, the integrated circuit package including a plurality of pads disposed on a surface of the integrated circuit package,
wherein the primary communication path is configured to connect the communication circuit to a first bonding finger from among the plurality of bonding fingers,
the secondary communication path is configured to connect the communication circuit to a second bonding finger from among the plurality of bonding fingers,
the second primary communication path is configured to connect the communication circuit to a third bonding finger from among the plurality of bonding fingers, and
the second secondary communication path is configured to connect the communication circuit to a fourth bonding finger from among the plurality of bonding fingers.

10. The NFC communications device according to claim 9, wherein the second bonding finger is configured and arranged to be located immediately adjacent to the first bonding finger, and wherein the third bonding finger is configured and arranged to be located immediately adjacent to the fourth bonding finger.

11. The NFC communications device according to claim 9, wherein each of the secondary communication path and the second secondary communication path is configured and arranged to be connected to a ground potential.

12. The NFC communications device according to claim 9, wherein the second bonding finger is directly connected to the fourth bonding finger to form a current loop.

13. The NFC communications device according to claim 9, wherein the second bonding finger is configured and arranged to be connected to the fourth bonding finger, through at least one additional bonding finger from among the plurality of bonding fingers, to form a current loop.

14. The NFC communications device according to claim 1, wherein the communication circuit comprises:
a demodulator configured to extract an informational signal from the current signal,
wherein the signal detector is further configured to supply the current signal directly to the demodulator.

15. The NFC communications device according to claim 1, wherein the communication circuit comprises:
a voltage amplifier configured to scale a voltage of the current signal to a predetermined voltage level,
wherein the signal detector is further configured to supply the current signal to the voltage amplifier.

16. The NFC communications device according to claim 1, wherein the current signal is galvanically isolated from the received input signal.

17. The NFC communications device according to claim 1, wherein the primary communication path is a first coil, wherein the secondary communication path is a second coil, and wherein the first coil and the second coil are configured and arranged to form a transformer.

18. The NFC communications device according to claim 1, further comprising:
an integrated circuit package that houses the communication circuit,
wherein the signal detector is located outside the integrated circuit package.

19. The NFC communications device according to claim 7, wherein at least one of the secondary communication path and the second secondary communication path are configured and arranged to originate and to terminate at the communication circuit.

20. A method for generating a current signal representative of an input signal received by an NFC communications device for use in a communication circuit of the NFC communications device, the method comprising:
supplying the received input signal to the communication circuit via a primary communication path; and
inducing, through proximity of a secondary communication path to the primary communication path, the current signal in the secondary communication path.
